(19) United States
(12) Patent Application Publication
(10) Pub. No.: US 2012/0071150 A1
(43) Pub. Date: Mar. 22, 2012

(54) CALL MANAGEMENT METHOD FOR MOBILE PHONE

(75) Inventor: DAN-BO GONG, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/044,505

(22) Filed: Mar. 9, 2011

(30) Foreign Application Priority Data
Sep. 16, 2010 (CN) 201010283628.9

(51) Int. Cl. H04M 3/00

(52) U.S. Cl. 455/418

(57) ABSTRACT

The present disclosure provides a call management method for a mobile phone. The mobile phone may be set with a preset period and a preset phone number. The mobile phone determines whether a call time of an incoming call is in the preset period. If the call time is in the preset period, the mobile phone may further determines whether a phone number of the incoming call conforms to the preset phone number. The mobile phone denies the incoming call when the phone number does not conform to the preset phone number.

### BACKGROUND

1. Technical Field

The present disclosure relates to a call management method for a mobile phone.

2. Description of Related Art

Mobile phones, while widely used, can allow undesired incoming calls, such that the users may occasionally turn the mobile phones off to avoid the undesired incoming calls. However, such operation for the mobile phones is still inconvenient.

### BRIEF DESCRIPTION OF THE DRAWINGS

FIG. 1 is a block diagram of one embodiment of a mobile phone.

FIG. 2 is a block diagram of one embodiment of a filter system shown in FIG. 1.

FIG. 3 is a flowchart illustrating one embodiment of a call management method for a mobile phone.

FIG. 4 is a flowchart illustrating one embodiment of a setting procedure of the call management method of FIG. 3.

### DETAILED DESCRIPTION

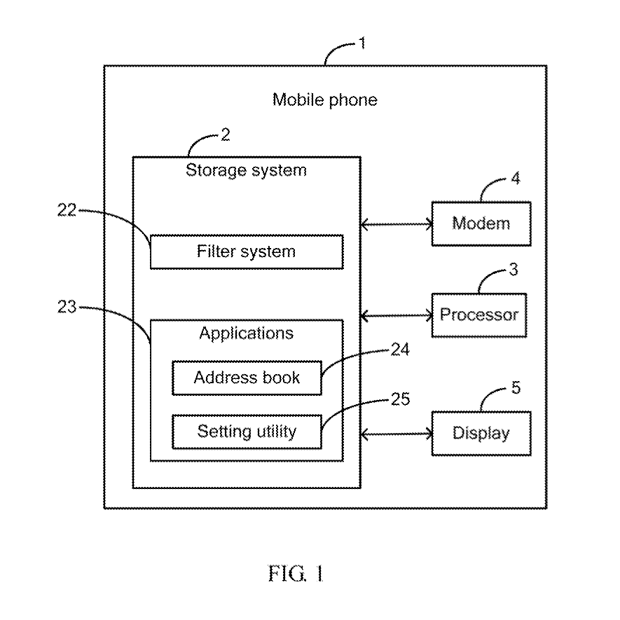

FIG. 1 is a block diagram of one embodiment of a mobile phone 1. The mobile phone 1 includes a storage system 2, a processor 3, a modem 4, and a display 5. The modem 4 is configured to process wireless signals, such as signals of incoming calls and outgoing calls of the mobile phone 1. The modem 4 may include various circuitry related to processing EDGE, 3G, or 4G telecommunication protocols, for examples. The display 5 may be a LCD, for example. A filter system 22 and applications 23 are stored in the storage system 20. The applications 23 may include an address book 24 and a setting utility 25.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

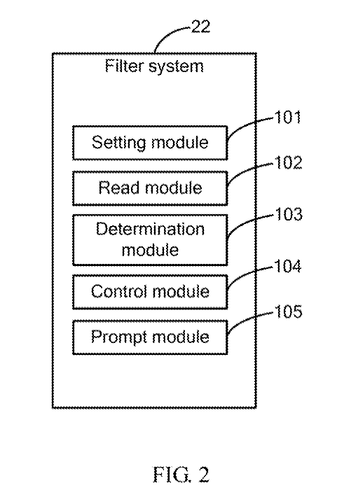

FIG. 2 is a block diagram of one embodiment of the filter system 22 shown in FIG. 1. The filter system 22 may filter an incoming call on the mobile phone 1 during specific occasions, such as a meeting, sleep time, or movie time. The filter system 22 includes a setting module 101, a read module 102, a determination module 103, a control module 104, and a prompt module 105. The modules 101-105 may comprise computerized code in the form of one or more programs that are stored in the storage system 2. The computerized code includes instructions that are executed by the processor 3 to provide functions for the modules 101-105.

The setting module 101 is operable to set a preset period and a preset phone number. The preset period and the preset phone number are filter conditions used to filter the incoming call on the mobile phone 1. The read module 102 is operable to read a call time and an phone number of the incoming call from the modem 4. The determination module 103 is operable to determine whether the call time is in the preset period, and determine whether the phone number conforms to the preset phone number.

The control module 104 denies the incoming call when the phone number does not conform to the preset phone number, and accepts the incoming call when the call time is not in the preset period. The control module 104 accepts the incoming call when the phone number conforms to the preset phone number. The prompt module 105 may display a message on the display 5 indicating the phone number has been denied when the control module 104 denies the incoming call.

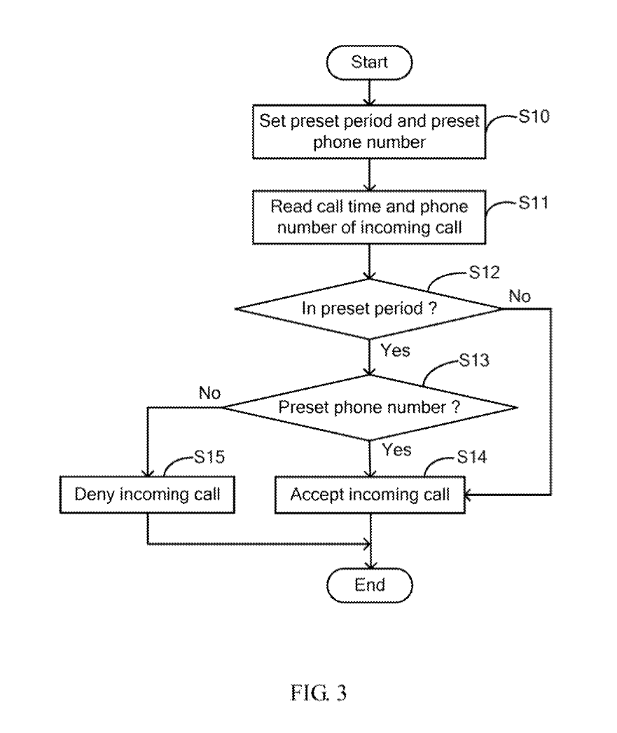

FIG. 3 is a flowchart illustrating one embodiment of a call management method for the mobile phone 1. Depending on the embodiment, additional blocks in the flow of FIG. 3 may be added, others removed, and the ordering of the blocks may be changed.

In block S10, the setting module 101 sets the preset period and the preset phone number in response to setting requirements of a user. The user may use a keypad or a touchscreen of the mobile phone 1 to set the preset period and the preset phone number.

In block S11, the read module 102 reads the call time and the phone number of the incoming call from the modem 4.

In block S12, the determination module 103 determines whether the call time is in the preset period. If the call time is not in the specific period, block S14 is implemented.

If the call time is in the preset period, in block S13, the determination module 103 determines whether the phone number conforms to the preset phone number.

If the phone number conforms to the preset phone number, in block S14, the control module 104 accepts the incoming call.

If the phone number does not conform to the preset phone number, in block S15, the control module 104 denies the incoming call.

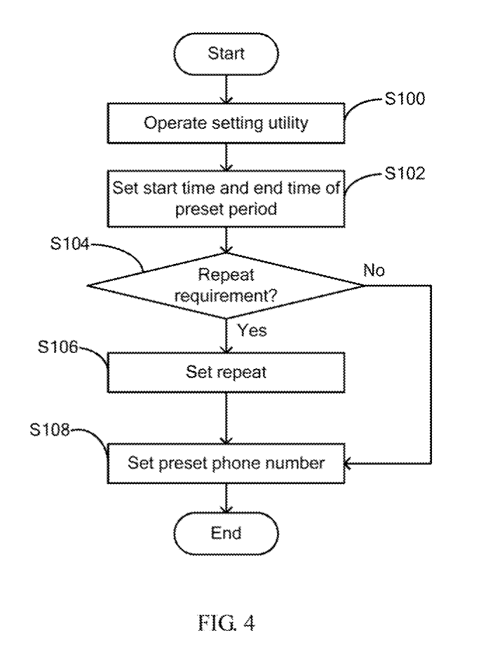

FIG. 4 is a flowchart illustrating a setting procedure of the method of FIG. 3. Depending on the embodiment, additional blocks in the flow of FIG. 4 may be added, others removed, and the ordering of the blocks may be changed.

In block S100, the setting utility 25 is operated by the user to activate the setting module 101.

In block S102, the setting module 101 sets a start time and an end time of the preset period. For example, if the user has a meeting of 14:30-16:30, 14:30 may be set as the start time and 16:30 may be set as the end time.

In block S104, the determination module 103 determines whether a repeat requirement for the preset period exists. If no repeat requirement for the preset period exists, block S108 is implemented.

If the repeat requirement for the preset period exists, in block S106, the setting module 101 sets a repeat of the preset period. For example, if the meeting is held on every Wednesday, the specific period may be set to repeat on every Wednesday.

In block S108, the setting module 101 sets the preset phone number.

The present disclosure provides a method for filtering incoming calls on a mobile phone. The mobile phone may filter the incoming call during a specific period, such that the user experience is improved.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented call management method for a mobile phone, comprising:
reading a call time and a phone number of an incoming call of the mobile phone;
determining whether the call time is in a preset period set in the mobile phone;
determining whether the phone number conforms to a preset phone number set in the mobile phone when the call time is in the preset period; and
denying the incoming call when the phone number does not conform to the preset phone number.

2. The method of claim 1, further comprising:
accepting the incoming call when the call time is not in the preset period.

3. The method of claim 1, further comprising:
accepting the incoming call when the phone number conforms to the preset phone number.

4. A mobile phone, comprising:
a storage system;
at least one processor;
one or more programs stored in the storage system and being executable by the at least one processor, the one or more programs comprising:
a setting module operable to set a preset period and a preset phone number;
a read module operable to read a call time and a phone number of an incoming call;
a determination module operable to determine whether the call time is in the preset period, and determine whether the phone number conforms to the preset phone number; and
a control module operable to accept or deny the incoming call.

5. The mobile phone of claim 4, wherein the control module denies the incoming call when the phone number does not conform to the preset phone number.

6. The mobile phone of claim 4, wherein the control module accepts the incoming call when the call time is not in the preset period.

7. The mobile phone of claim 4, wherein the control module accepts the incoming call when the phone number conforms to the preset phone number.

8. A storage medium having stored thereon instructions that, when executed by a processor, causing the processor to perform a call management method for a mobile phone, wherein the method comprises:
read a call time and a phone number of an incoming call of the mobile phone;
determine whether the call time is in a preset period set in the mobile phone;
determine whether the phone number conforms to a preset phone number set in the mobile phone when the call time is in the preset period; and
deny the incoming call when the phone number does not conform to the preset phone number.

9. The storage medium of claim 8, wherein the method comprises:
accept the incoming call when the call time is not in the preset period.

10. The storage medium of claim 8, wherein the method comprises:
accept the incoming call when the phone number conforms to the preset phone number.
